(19) United States
(12) Patent Application Publication
(10) Pub. No.: US 2005/0015426 A1
(43) Pub. Date: Jan. 20, 2005

(54) Communicating data over a communication link

(76) Inventors: Robert J. Woodruff, Banks, OR (US); Oscar P. Pinto, Portland, OR (US)

Correspondence Address: Timothy N. Trop;TROP, PRUNER & HU, P.C., STE 100, 8554 KATY FWY, HOUSTON, TX, 77024-1841, US

(21) Appl. No.: 10/619,264

(22) Filed: Jul. 14, 2003

(51) Int. Cl. G06F 15/16

(52) U.S. Cl. 709/200

(57) ABSTRACT

A technique includes providing a signal to a communication link to communicate a data value across the communication link. At least one wavelength is selectively introduced to the signal. The wavelength(s) identify the data value.

### BACKGROUND

The invention generally relates to communicating data over a communication link.

A typical computer system may use serial communication to communicate data to devices outside of the computer system, as well as communicate data between components of the system. In serial communication, bytes of data are typically broken down into their constituent bits, and the data is transmitted one bit at a time over a serial communication link.

In a typical computer system, serializing/de-serializing (Serdes) devices may be located at both ends of a particular serial communication link. For transmission of data over the serial communication link, the Serdes device may include an encoder to encode (pursuant to an 8B/10B encoding scheme or scrambling encoding scheme, as just a few examples) the data to be transmitted and a transmitter to transmit the data over the serial communication link. The encoding is used to balance the DC level of the data that is communicated over the serial communication link as well as ensure a sufficient number of logic level transitions appear on the serial communication link. The DC balancing permits the use of small coupling capacitors, and a sufficient number of logic level transitions aids in synchronizing the transmitted data to a clock signal. For the reception of data from the serial communication link, the Serdes device may include a receiver to recover the data from the serial communication link one bit at a time and a decoder to remove the decoding that is introduced by the encoder on the transmitting end of the serial communication link.

Serial communication links may be built from copper wires, along which electric signals propagate to transmit data. Serial communication links may also be formed from optical communication links (such as optical fibers), along which pulses of light propagate to transmit data. The speed at which these links can be driven (measured by number of bits per second) determines the amount of data that can be transferred in and out of the computer system and ultimately the overall system throughput.

Thus, there is a continuing need for an arrangement to increase the rate at which data may be communicated over a communication link, such as a serial communication link, for example.

### BRIEF DESCRIPTION OF THE DRAWING

FIGS. 1, 2 and 5 are flow diagrams depicting techniques to communicate data over a communication link according to different embodiments of the invention.

FIG. 3 is a block diagram depicting a communication system to communicate data over an optical serial communication link according to an embodiment of the invention.

FIG. 4 is a block diagram of a transceiver according to an embodiment of the invention.

FIG. 6 is a block diagram of a computer system according to an embodiment of the invention.

### DETAILED DESCRIPTION

In accordance with embodiments of the invention, techniques and communication systems are described herein to communicate more than one bit of data at a time over a serial communication link. More specifically, in some embodiments of the invention, these techniques and systems assign wavelengths to data values that are to be communicated over the serial communication link. Thus, in some embodiments of the invention, a particular data value is identified by the presence or absence of one or more wavelengths in the signal that is communication over the serial communication link. For an optical communication link (such as an optical fiber), the wavelengths are associated with one or more colors so that a particular data value is communicated across the optical communication link by communicating the appropriate color(s) over the link. Thus, in some embodiments of the invention, the presence or absence of one or more colors in the optical signal that is communicated over the optical communication link identifies a particular data value.

More specifically, in some embodiments of the invention, the encoding scheme described herein recognizes that a byte of data indicates one out of possibly 256 values. In other words, a byte of data represents integer values in the range of 0 to 255. In some embodiments of the invention, each particular byte value is assigned a unique wavelength so that each of the 255 byte values is assigned to one of 255wavelengths.

For embodiments of the invention in which the communication link is an optical communication link (such as an optical fiber, for example), each wavelength corresponds to a different color of light that is communicated over the optical communication link. Because the wavelength of visible light falls in the range between 4000 to 7000 angstroms, the 255 byte values corresponds to wavelengths in this visible spectrum, in some embodiments of the invention. Thus, each wavelength may be a different color of light in this visible light spectrum. As a more specific example, in some embodiments of the invention, the byte values 0-255 may be represented by different wavelengths in the range of 4000-4255 angstroms. For example, in this scheme, the presence of a wavelength of 4000 angstroms in the transmittal optical signal indicates the byte value of “0,” the presence of a wavelength of 4010 angstroms indicates the byte value of “10,” the presence of a wavelength of 4132 angstroms indicates the byte value of “132,” Thus, each value 0 to 255 is represented by a different unique wavelength of light, in some embodiments of the invention.

In other embodiments of the invention, wavelengths that are not in the visible spectrum of light may be used to indicate different data values. Therefore, in some embodiments of the invention, to indicate a particular data value on an optical communication link (for example), a wavelength outside of the range between 4000 to 7000 angstroms may be introduced into a signal that is communicated to the optical communication link for purposes of indicating or identifying a particular data value.

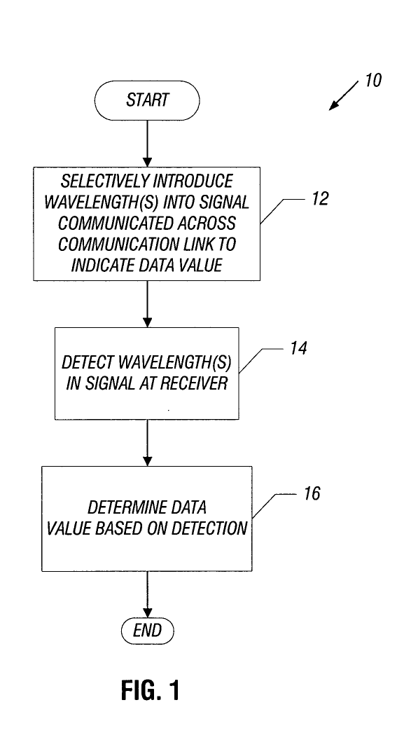

Referring to FIG. 1, therefore, in accordance with some embodiments of the invention, a technique 10 includes selectively introducing (block 12) wavelength(s) into a signal that is communicated across a communication link to indicate a particular data value. As noted above, in some embodiments of the invention, the signal may be an optical signal, the communication link may be an optical fiber and the wavelengths may correspond to visible wavelengths (i.e., colors) of light. In accordance with the technique 10, the wavelength(s) in this signal are detected at a receiver that is coupled to the communication link, as depicted in block 14. Next, in accordance with the technique 10, the communicated data value is determined (block 16), based on this detection. Thus, in some embodiments of the invention, a transmitter may communicate one or more colors to an optical fiber to indicate particular data value, and a receiver recovers the data by detecting the one or more colors from the optical fiber.

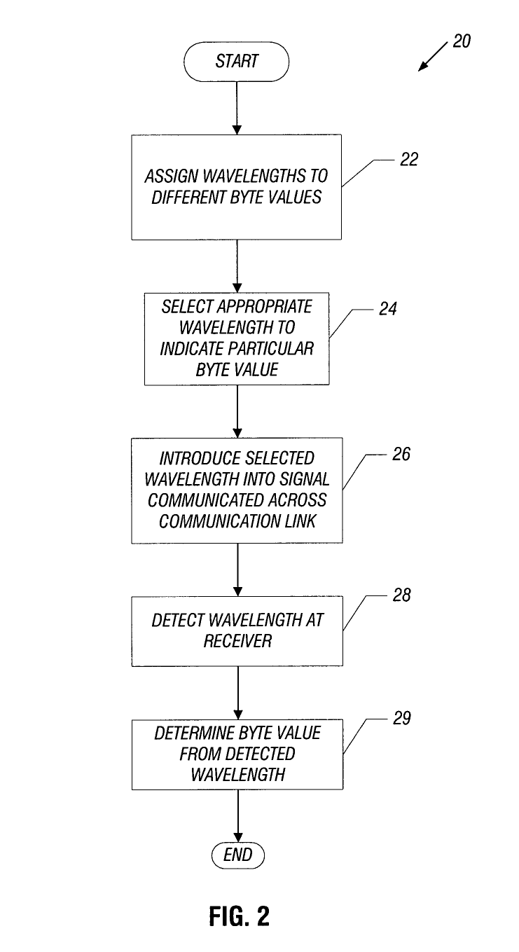

As discussed above, in some embodiments of the invention, different wavelengths may be assigned to different byte values. Therefore, referring to FIG. 2, in some embodiments of the invention, a technique 20, which is a more specific implementations of the technique 10, may include assigning wavelengths to different byte values, as depicted in block 22. As depicted in block 24 of the technique 20 to communicate a particular byte value over the communication link, an appropriate wavelength is selected to indicate the particular byte value. Next, in accordance with the technique 20, the selected wavelength is introduced (block 26) into the signal that is communicated across the communication link. At the receiver, the wavelength that is communicated via the signal is detected, as depicted in block 28. Thus, a byte value may be determined (block 29) from the detected wavelength.

Therefore, as can be seen from the techniques described above, a particular data value, such as a byte, may be communicated at once over a serial communication link, as opposed to communicating the byte of data over the link one bit at a time. In contrast, a conventional technique for communicating a byte of data across a serial communication link typically involves at least eight clock cycles, i.e., each clock cycle being associated with a particular bit of data. Furthermore, in conventional systems, more than eight clock cycles may be used to communicate a particular byte data over the serial communication link. In this manner, in a conventional serial communication system, an encoding scheme may be used to balance the DC level of the communication link, as well as ensure sufficient transitions occur on the serial communication link for purposes of sufficiently recovering the clock and data signals.

More specifically, in conventional serial communication systems, the system may include a clock data recovery (CDR) circuit that recovers data and clock signals from the serial signal that is communicated on the serial communication link. In this manner, the serial signal may be encoded according to a scrambled Non-Return-to-Zero (NRZ) encoding scheme, a Coded Mark Inversion (CMI) coding or DC-free coding scheme, such as 8B/10B, etc. The DC-free encoding schemes ensure that the signal that is communicated across the serial communication link does not contain a long-term DC value. To accomplish this, two additional bits are added to each byte of data communicated across the serial communication link, for purposes of ensuring a long-term number of “1's” and “0's” across the link. However, such encoding introduces more than eight clock cycles to transmit a particular byte of data. Thus, conventional techniques for serial communication link transmission involve more than eight clock cycles to communicate a particular byte of data.

In contrast, in accordance with some embodiments of the invention, because each value of the byte to be communicated over a serial communication link is represented by a unique wavelength, only one clock cycle may be used to transfer an entire byte of data. In this context, a clock cycle is defined by the period that includes the time in which the wavelength(s) appear and the subsequent time period in which the wavelength(s) do not appear in the communicated signal. As a more specific example, for communication over an optical fiber, in some embodiments of the invention, the clock cycle at the transmitter is defined by the period during which the appropriate source(s) communicate light that has the appropriate wavelength(s) to the optical fiber and the subsequent period in which the light from the optical sources are turned off. Thus, this communication forms pulses of light that indicate the bytes of data, and these pulses are separated by times of no light on the optical fiber. At the receiver, the clock edges may be determined by the times at which the detected light appears and disappears.

As discussed above, in some embodiments of the invention, a particular wavelength may be introduced into the signal that is communicated across the communication link for purposes of indicating a byte value. In other embodiments of the invention, a particular wavelength may indicate or indentify any size of binary data and is not limited to indicating a byte value. For example, depending on the particular embodiment of the invention, a particular wavelength may indicate or identify a data value of two bytes, a data value of four bytes, etc. Furthermore, a data value less than one byte, such as a nibble (for example), may be communicated via a particular wavelength, as further described below.

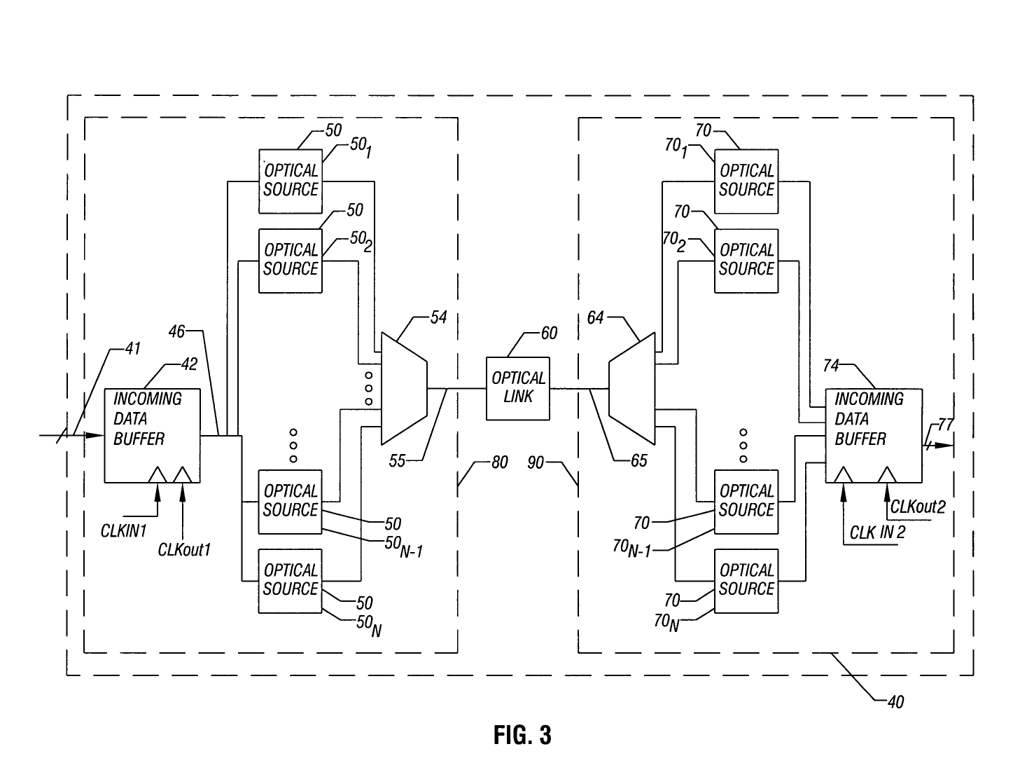

As a more specific example of a communication system 40 in accordance with some embodiments of the invention, FIG. 3 depicts a one-way communication path 40 that illustrates the communication of data over an optical communication link 60 from a transmitter 80 to a receiver 90. As depicted in FIG. 3, in accordance with some embodiments of the invention, the transmitter 80 may include, for example, an incoming data buffer 42 that receives incoming data that is communicated by electrical signals that propagate over electrical communication lines 41. As depicted in FIG. 3, the incoming data may be clocked pursuant to a clock signal called CLKIN1. Electrical communication output terminals 46 from the incoming data buffer 42 provide electrical signals that indicate each byte of data to be communicated over the optical communication link 60. The byte of data indicated on the output terminals 46 change in synchronization with an output clock signal called CLKOUT1. Thus, on each cycle of the CLKOUT1 clock signal, the output terminals 46 electrically indicate another byte of data to be communicated to the optical communication link 60 by the transmitter 80.

In accordance with some embodiments of the invention, the electrical signals on the output terminals 46 control a particular optical source 50 (N optical sources 50₁, 50₂, 50_{N-1} and 50_{N}, depicted as examples) that is turned on for purposes of generating an optical signal for communication over the optical communication link 60. More specifically, in some embodiments of the invention, the optical sources 50 are addressed so that a particular byte of data (as indicated by the output terminals 46) uniquely addresses one of the optical sources 50 to turn that optical source 50 on. The other optical sources 50, in turn, remain turned off. Because each optical source 50 generates light associated with a different wavelength (or color), each byte value turns on a different optical source 50 to generate light at a different wavelength in the optical signal that is communicated to the optical communication link 60.

The optical sources 50 are optically coupled together by an optical multiplexer 54. An optical output terminal 55 of the multiplexer 54, in turn, is coupled to the optical communication link 60. Therefore, depending on the particular byte value appearing at the output terminal 46, a corresponding wavelength of that light is communicated to the optical communication link 60.

As depicted in FIG. 3, the optical receiver 90 includes a de-multiplexer 64 that includes an optical input terminal 65 that is coupled to receive an optical signal from the optical communication link 60. The de-multiplexer 64 de-multiplexes the optical signal that is received from the optical communication link 60 according to the wavelength of the signal. The de-multiplexer 64 is coupled to N optical detectors 70 (optical detectors 70₁, 70₂, 70_{N-1} and 70_{N}, depicted as examples). Each optical detector 70, in turn, is associated with a different one of the wavelengths produced by the optical sources 50 so that the de-multiplexer routes the received optical signal (i.e., routes light) to the optical detector 70 that is associated with the wavelength present in the optical signal The other non-selected optical detectors 70, in some embodiments of the invention, do not receive any light.

Thus, as an example, the optical detector 70, may be associated with the optical source 50₁, the optical detector 70₂ may be associated with the optical source 50₂, etc. Due to this arrangement, because only one wavelength is communicated over the optical communication link 60 in some embodiments of the invention, only one of the optical detectors 70 receives an optical signal from the de-multiplexer 64. Thus, by determining which detector 70 receives an optical signal from the optical communication link 60, a determination may be made of the particular byte value that was communicated across the optical communication link 60.

The optical detector 70 provide electrical output signals to an outgoing data buffer 74, and these electrical signals indicate the byte of data that has been detected from the optical communication link 60. As depicted in FIG. 3, the receipt of this data from the optical detector 70 may be synchronized to an incoming clock signal called CLKIN2, and communication of the outgoing data from the outgoing data buffer 74 (via electrical output terminals 77) may be synchronized to an outgoing clock signal called CLKOUT2.

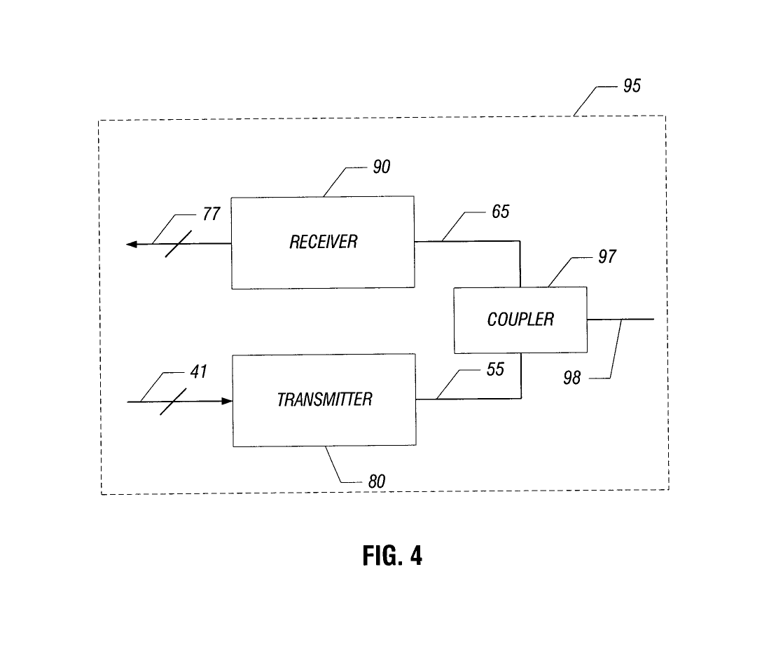

FIG. 3 depicts one-way communication across the optical communication link 60. However, according to some embodiments of the invention, the communication across the optical communication link 60 may occur in both directions. Therefore, a transmitter 80 and a receiver 90 may be located on each end of the optical communication link 60, in accordance with some embodiments of the invention. Such an arrangement forms a transceiver 95 that is depicted in FIG. 4. Referring to FIG. 4, in some embodiments of the invention, the transceiver 95 includes a transmitter 80 and a receiver 90 that have their output terminals 65, respectively, coupled together by an optical coupler 97. An optical output terminal 98 of the coupler 97 couples the transceiver 95 to the optical communication link 60. As depicted in FIG. 4, data that is to be communicated across the optical communication link 60 is received by the transmitter 80 over its electrical input terminals 41; and data received from the optical communication link 60 by the receiver 90 is furnished by the transceiver 95 via the electrical output terminals 77 of the receiver 90. Other variations are possible and are within the scope of the appended claims.

As discussed above, in some embodiments of the invention, the encoding/decoding scheme identifies a particular byte value with a particular data value. However, other encoding/decoding schemes may be used in other embodiments of the invention. For example, in accordance with some embodiments of the invention, the encoding/decoding scheme includes encoding a particular bit state using an assigned wavelength. Thus, each byte may be represented by the presence or absence of more than one wavelength.

As noted above, depending on the particular embodiment of the invention, a particular wavelength may be used to indicate or identify any size of binary data, whether the data is larger than or smaller than a byte. However, regardless of size of data being communicated via the wavelengths, the communication system 40 (and thus, the corresponding transceiver 95) includes the appropriate number of optical sources 50 and detectors 70.

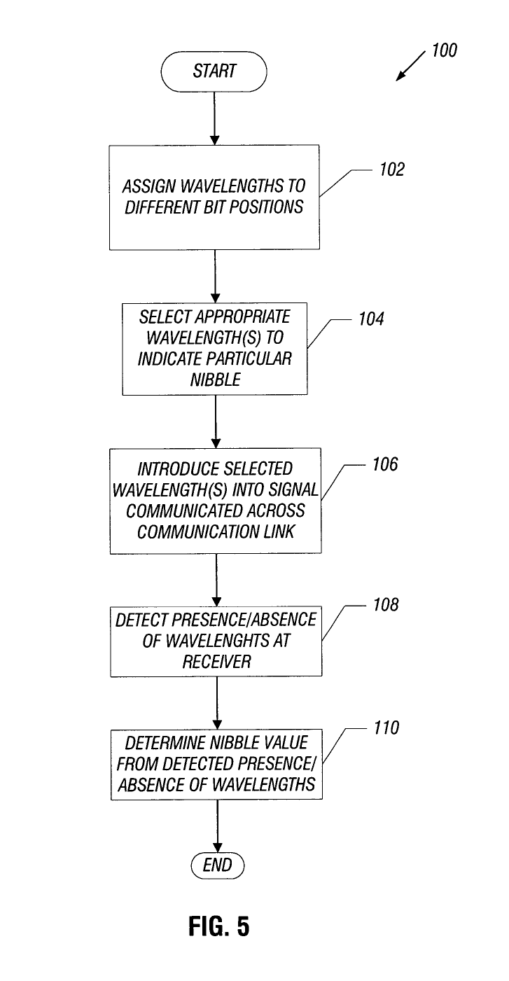

More specifically, in some embodiments of the invention, a technique 100 that is depicted in FIG. 5 may be used. Pursuant to the technique 100, wavelengths are assigned to different bit positions, as depicted in block 102. The bit positions may be the bit positions of a nibble, i.e., four bits of data. Thus, pursuant to the technique 100, one wavelength may be assigned to bit position zero, another wavelength may be assigned to bit position one, another wavelength may be assigned to bit position two and another wavelength may be assigned to bit position three. Thus, for this example, each bit position of the nibble is associated with a particular wavelength. Thus, the presence or absence of a particular wavelength in the signal that is communicated over the communication link indicates the state of the bit.

For example, in some embodiments of the invention, the presence of a particular wavelength in the signal indicates a bit state of one for the associated bit position; and the absence of the wavelength for the particular bit position indicates a bit state of zero. The present and absent wavelengths may indicate zero and one bit states, respectively, in other embodiments of the invention. Continuing with the description of the technique 100, in some embodiments of the invention, the technique 100 includes selecting the appropriate wavelength(s) to indicate the particular nibble, as depicted in block 104. As a more specific example, for a nibble a value of “4,” (i.e., a binary value of “0100”) the wavelength corresponding to bit positions two is included in the optical signal; and the wavelengths associated with the other bit position are not included in the optical signals.

Subsequent to the block 104, the technique 100 includes introducing selected wavelength(s) into the signal that is communicated across the communication link, as depicted in block 106 (assuming a nibble value of “0000” is not being communicated across the link).

At the receiver, the presence or absence (depending on the particular embodiment of the invention) is detected, as depicted in block 108. From the detected wavelength(s) in the optical signal, the nibble value is determined from the detected wavelengths, as depicted in block 110.

In the above-described encoding/decoding scheme, only four wavelengths are used to communicate a particular nibble value across the communication link. Thus, in these embodiments of the invention, the number of optical sources (4) may be significantly less than if each possible nibble value (16 possible values) were assigned a unique wavelength. Other variations are possible.

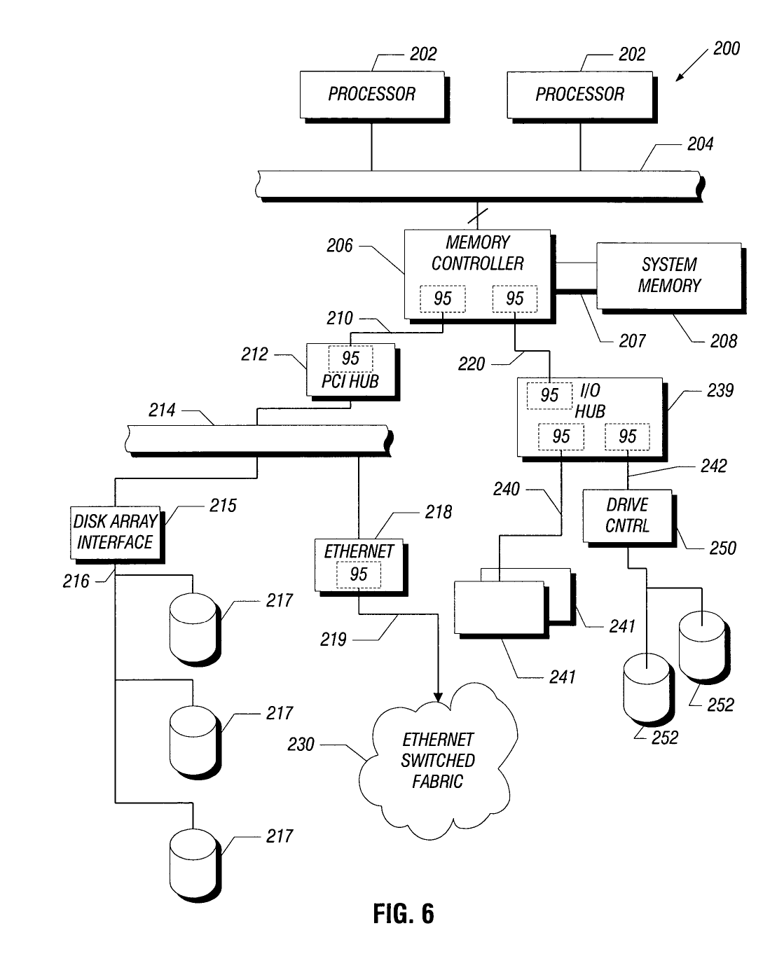

The transceiver 95 may be used to form various serial interfaces for a computer system 200 that is depicted in FIG. 6. More specifically, in some embodiments of the invention, the computer system 200 may include multiple processors 202 (central processing units (CPUs) such as Pentium processors, for example) that are coupled to a system bus 204. The system bus 204, in turn, may be coupled to a memory controller 206 that controls communications between components of the computer system 200 and a system memory 208 that is coupled to a memory bus 207. In some embodiments of the invention, the memory controller 206 communicates with various hubs via serial communication links. Each of these serial communication links, in turn, may include a transceiver 95 that is located on each end of the serial communication link. In some embodiments of the invention, one or more of the serial communication links may include optical fibers and thus, may form optical communication links. One or more of the serial communication links may include electrical wires (copper wires, for example).

For example, in some embodiments of the invention, the memory controller 206 may communicate with a Peripheral Component Interconnect (PCI) hub 212 via a serial communication link 210. The PCI Specification is available from The PCI Special Interest Group, Portland, Oreg. 97214. Thus, a transceiver 95 is located on each end of serial communication link 210 in the memory controller 206 and the PCI hub 212. The PCI hub 212 may be coupled to a PCI bus 212 that, in turn, is coupled to a disk array interface 215. The disk array interface 215, in turn, may be coupled to a bus 216 that, in turn, is coupled to disk drives 217. As an example, the disk drives 217 may form a redundant array of inexpensive disks (RAID) array.

An Ethernet interface 218 may be coupled to the PCI bus 214 to couple the computer system 200 to Ethernet switched fabric 230. For purposes of communicating with the fabric 230, the Ethernet interface 218 may include a transceiver 95 that is coupled via a serial communication link 219 to the fabric 230. The Ethernet switched fabric 230 may be an optical network and use the optical Ethernet protocol that is described in the Institute of Electrical and Electronics Engineers, Inc. (IEEE) Std. 802.3, 2000 Edition, published on Oct. 20, 2000, and in the IEEE 802.3(a)(e) Supplement, dated Jun. 12, 2002.

In some embodiments of the invention, the memory controller 206 may communicate with an input/output (1/O) hub 239 via a serial communication link 220. Thus, the memory controller 206 may include a transceiver 95 at one end of the serial communication link 220; and the I/O hub 239 may include a transceiver 95 at the other end of the serial communication link 220.

The I/O hub 239 may include other transceivers 95 for purposes of communicating with other devices. For example, the I/O hub 239 may include a transceiver 95 for purposes of communicating with (via a serial communication link 240) input devices 241 (a keyboard and/or a mouse, for example). Furthermore, the I/O hub 239 may include a transceiver 95 for purposes of communicating with (via a serial communication link 242) a drive control interface 250. The drive control interface 250 may also include a transceiver 95 on the other side of the serial communication link 242 for purposes of communicating with hard drives 252. Other transceivers 95, serial communication links and variations from that shown in FIG. 6 are possible in other embodiments of the invention.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

1. A method comprising:
providing a signal to a communication link to communicate a data value across the communication link; and
selectively introducing at least one wavelength to the signal, said at least one wavelength identifying the data value.

2. The method of claim 1, wherein the presence of said at least one wavelength in the signal identifies the data value.

3. The method of claim 1, wherein said introducing comprises:
introducing a wavelength identifying a byte value.

4. The method of claim 1, wherein said introducing comprises:
introducing a wavelength identifying a bit state.

5. The method of claim 1, wherein said introducing comprises:
introducing wavelengths identifying different bit states of a digital value.

6. The method of claim 5, wherein the digital value comprises a nibble.

7. The method of claim 1, wherein the providing comprises:
providing the signal to an optical fiber.

8. A method comprising:
receiving a signal from a communication link, the communication link to communicate a data value; and
detecting the presence of at least one wavelength in the signal to identify the data value.

9. The method of claim 8, wherein the detecting comprises:
detecting a wavelength identifying a byte value.

10. The method of claim 8, wherein the detecting comprises:
detecting a wavelength identifying a bit state.

11. The method of claim 8, wherein the detecting comprises:
detecting wavelengths identifying different bit states of a digital value.

12. The method of claim 11, wherein the digital value comprises a nibble.

13. The method of claim 8, wherein the receiving comprises:
receiving the signal from an optical fiber.

14. The method of claim 8, wherein the receiving comprises:
receiving the signal from an optical communication link.

15. A receiver comprising:
at least one detector coupled to a communication link to detect the presence of at least one wavelength in a signal received from the communication link to identify data communicated over the communication link.

16. The receiver of claim 15, wherein said at least one wavelength comprises a wavelength identifying a byte value.

17. The receiver of claim 15, wherein said at least one wavelength comprises a wavelength identifying a bit state.

18. The receiver of claim 15, wherein said at least one detector receives the signal from an optical fiber.

19. The receiver of claim 15, wherein said at least one detector comprises:
multiple detectors, each detector to detect the presence of a different wavelength in the signal.

20. A transmitter comprising:
at least one source to provide a signal to a communication link to communicate a data value and selectively introduce at least one wavelength to the communication link, said at least one wavelength identifying the data value.

21. The transmitter of claim 20, wherein the present of said at least one wavelength identifies the particular data value.

22. The transmitter of claim 20, wherein said at least one wavelength comprises a wavelength identifying a byte value.

23. The transmitter of claim 20, wherein said at least one wavelength comprises a wavelength identifying a bit state.

24. The transmitter of claim 20, wherein said at least one source provides the signal to an optical communication link.

25. A system comprising:
a communication link;
a transmitter to provide a signal to the communication link to communicate a data value over the communication link and selectively introduce at least one wavelength to the signal, said at least one wavelength identifying the data value; and
a receiver coupled to the communication link to detect said at least one wavelength to identify the data value.

26. The system of claim 25, wherein the presence of said at least one wavelength identifies the particular data value.

27. The system of claim 25, wherein said at least one wavelength comprises a wavelength identifying a byte value.

28. The system of claim 25, wherein said at least one wavelength comprises a wavelength identifying a bit state.

29. The system of claim 25, wherein the communication link comprises an optical communication link.

30. A system comprising:
an optical fiber;
a transmitter to provide a signal to the optical fiber to communicate a data value over the optical fiber and selectively introduce at least one wavelength to the signal, said at least one wavelength identifying the data value and to indicate a particular data value; and
a receiver coupled to the optical fiber to detect said at least one wavelength to identify the data value.
